(19) United States
(12) Patent Application Publication
(10) Pub. No.: US 2010/0057293 A1
(43) Pub. Date: Mar. 4, 2010

(54) METHOD FOR RECOGNIZING A VERTICAL MISALIGNMENT OF A RADAR SENSOR

(76) Inventors: Dieter Hoetzer, Farmington Hills, MI (US); Ruediger Jordan, Stuttgart (DE); Oliver Schwindt, Rutesheim (DE)

Correspondence Address: KENYON & KENYON LLP, ONE BROADWAY, NEW YORK, NY, 10004, US

(21) Appl. No.: 12/305,137

(22) PCT Filed: Oct. 15, 2007
(86) PCT No.: PCT/EP2007/060931

§ 371 Date: Nov. 20, 2009

(30) Foreign Application Priority Data
Dec. 11, 2006 (DE) 102006058305.1

(51) Int. Cl. G01S 7/40; G06F 7/00

(52) U.S. Cl. 701/34; 342/173

(57) ABSTRACT

A method for recognizing a vertical misalignment of the radiation characteristic of a radar sensor of a control system for a motor vehicle, in particular of a driving speed and/or adaptive driving speed system, including the following steps: the receive power of the radar radiation reflected from an object is determined; the distance dependence and the horizontal angular dependence are compensated according to the radar equation; the functional dependence of the receive power, processed in this way, on the distance from the object is compared to an expected and stored curve of the receive power over the distance, and from this the vertical misalignment of the radiation characteristic of the radar sensor is inferred.

### FIELD OF THE INVENTION

The present invention relates to a method, computer program and computer program product for recognizing a vertical misalignment of the radiation characteristic of a radar sensor, in particular a long-range radar system of a control system for a motor vehicle, in particular of a distance and/or driving speed control system.

### BACKGROUND INFORMATION

Conventional methods and devices for recognizing misalignments, including those having a capability of self-correcting their sensor field of view, are available.

Thus, for example, German Patent. Application No. DE 100 19 182 A1 describes a method and a device for determining a misalignment of the radiation characteristic of a sensor for speed and distance controlling of a vehicle that represents a combination of two separate methods. The two individual methods are selected such that the one method has advantages in the areas in which the other method functions poorly, so that the weaknesses of the one method can be compensated by the strengths of the other method. Using this combination, it can be decided with great reliability whether a misalignment exists that can be corrected using suitable tracking measures, or whether a misalignment is present that is so extreme that the system has to be switched off.

The described method is suitable also for recognizing and/or correcting a vertical misalignment only if the radar sensor is able to measure the angle of elevation of the reflecting objects. Radar sensors having this additional function are expensive and are used only rarely in vehicles.

In vehicles, the radar sensors used are almost exclusively those that have only a limited ability to recognize a misalignment between the axis of the radar sensor and the vehicle axis or driving axis. Horizontal alignment compensation can be determined and compensated for example via a trajectory tracking of stationary objects. For vertical misalignment, this is not possible, because such radar sensors do not measure angles in the vertical direction, so that a misalignment cannot be recognized on the basis of trajectories.

A vertical misalignment can result in false horizontal angles, because the antenna diagram used corresponds, in section, essentially to 0° of vertical misalignment. If the vertical misalignment angle differs from 0°, the antenna diagram deviates strongly from the ideally used antenna diagram, and to this extent has only limited validity.

German Patent Application No. DE 197 07 590 A1 describes a method and a device for adjusting a distance sensor, in particular a distance radar system for a motor vehicle, in which the distance sensor is positioned using a known positioning device, in particular using a headlight adjusting device. For this purpose, measurement or data values of the distance sensor are read out, and are evaluated using at least one prespecified criterion in such a way that a service unit is able to indicate required directions of displacement of the distance sensor. This method and device do not enable the compensation of misalignments that result for example during operation of the vehicle, such as damages to, for example, a fender in which the radar sensor is installed, or given a high trailer weight, which can result in misalignment of the radar sensor.

Such misalignments have the consequence that the range of the sensor decreases. In this way, for example, vehicles traveling in front of the vehicle equipped with the sensor can be detected only within a limited range. In the case of a distance control system, the vehicle traveling in front is recognized too late when approached with a high relative speed, so that the home vehicle, i.e. the vehicle equipped with the sensor, can no longer be decelerated strongly enough, so that there is a danger of collision if the driver of the home vehicle does not act in time. Moreover, there is also the danger that the misalignment may result in the misclassification of bridges or sign gantries as obstacles, so that an abrupt braking of the vehicle takes place even though no obstacle actually exists in front of the vehicle.

### SUMMARY

A method according to an example embodiment of the present invention may make it possible to recognize and to compensate a vertical misalignment even of a radar sensor that does not measure vertical angles, in particular during operation of the vehicle.

In accordance with an example embodiment of the present invention, the radar output received from objects at a distance is determined and stored, and this is compared with an expected radar output assuming a correctly aligned sensor, and from this comparison the vertical misalignment is inferred.

The example method takes advantage of the fact that the antenna characteristic has its highest sensitivity on the mid-axis. The greater the deviation from the mid-axis, the lower will be the received output from an object. Even if no misalignment can be determined from the measured output because the backscatter cross-section of the object is unknown, the receive power plotted over the distance has a characteristic curve that can be evaluated.

Thus, the comparison is preferably carried out only when the vehicle is not moving on an incline. This is because it has to be excluded that both the (observing) vehicle (home vehicle) and also the observed vehicle are situated on an incline, which cannot be determined until after the home vehicle has passed the location.

The presence of an incline can be advantageously determined on the basis of the inherent acceleration and longitudinal acceleration of the motor vehicle, which are already continually being acquired for known vehicle dynamics systems.

Advantageously, the vertical misalignment is determined in that, given a deviation of the determined receive power from the stored receive power, the gradient of the determined receive power over the distance from the object is determined, and from this the magnitude of the vertical misalignment is determined.

As an object, it may be advantageous to select moving objects, for example vehicles that are approaching or moving away, because in general the vertical position of stationary objects is unknown. Thus, for example posts, bridges, or manhole covers have completely different vertical positions. This is not the case for vehicles, in which a reflection point of approximately 0.5 m to 1 m above the roadway can be assumed.

### BRIEF DESCRIPTION OF THE DRAWINGS

Exemplary embodiments of the present invention are shown in the figures and are explained in more detail below.

FIG. 1a schematically shows a vehicle, having a properly adjusted radar sensor, traveling behind another vehicle.

FIG. 1b shows the measured receive power over the distance from the vehicle traveling in front in the situation shown in FIG. 1.

FIG. 2a shows a vehicle having a misaligned radar sensor, traveling behind another vehicle.

FIG. 2b shows the measured receive power over the distance from the vehicle traveling in front in the situation shown in FIG. 2a.

FIG. 3 shows the radiation characteristic of a radar sensor situated on a vehicle traveling behind another vehicle while traveling over a crest.

### DETAILED DESCRIPTION OF EXAMPLE EMBODIMENTS

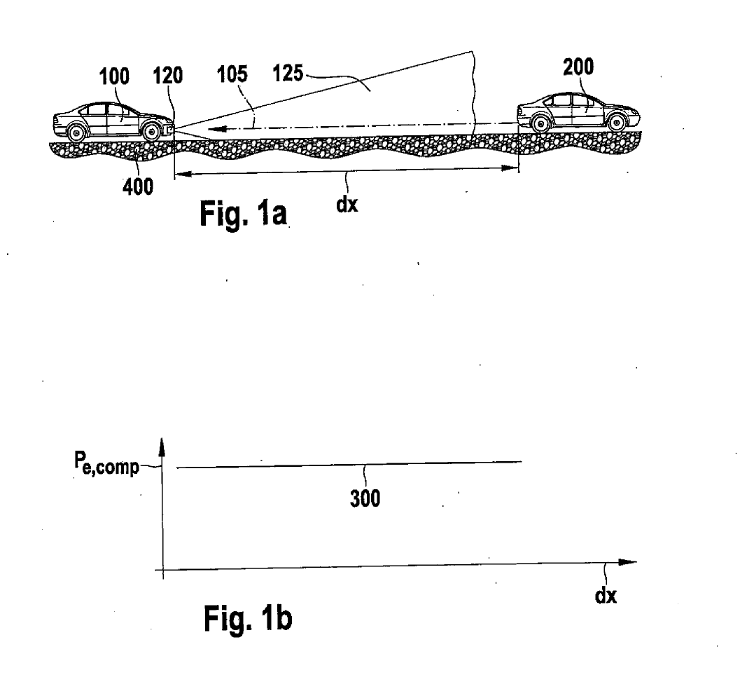

In FIGS. 1, 2, and 3, identical elements have been designated with identical reference characters.

FIG. 1 schematically shows a vehicle 100 that has a properly adjusted radar sensor 120. This radar sensor 120 has a sector-pattern sensor field of view 125 that is aligned with mid-axis 105 of the vehicle. In this way, given a flat roadway 400 a vehicle 200 traveling in front of vehicle 100 can be recognized through acquisition and evaluation of the radar radiation reflected by vehicle 200. In FIG. 1b, receive power P_{e, comp} is shown over distance dx from vehicle 200 traveling in front, after compensation of the distance dependence and the dependence on the horizontal angle.

The antenna characteristic shows its highest sensitivity on mid-axis 105. The greater the deviation from mid-axis 105 is, the lower becomes the receive power from an object, e.g. vehicle 200 traveling in front of vehicle 100. Although a misalignment cannot be determined from the measured power because the backscatter cross-section of vehicle 200 is unknown, the distance dependence of the receive power results in a characteristic curve that makes it possible to determine a vertical misalignment in the manner described below.

The distance from an object, for example vehicle 200 traveling in front of the home vehicle, from radar sensor 120 is measured directly.

The receive power is proportional to the reciprocal of the fourth power of distance dx. In the horizontal direction, what is known as a long-range radar sensor generally has several, for example four, antenna patches situated adjacent to one another. Horizontal angle a of the radar reflector can be determined from the ratio of the four received amplitude phase positions. Because the antenna gain in the horizontal direction G(α) is known, this attenuation can also be taken into account. Corresponding to the radar equation, the following value results for the compensated receive power in dB:

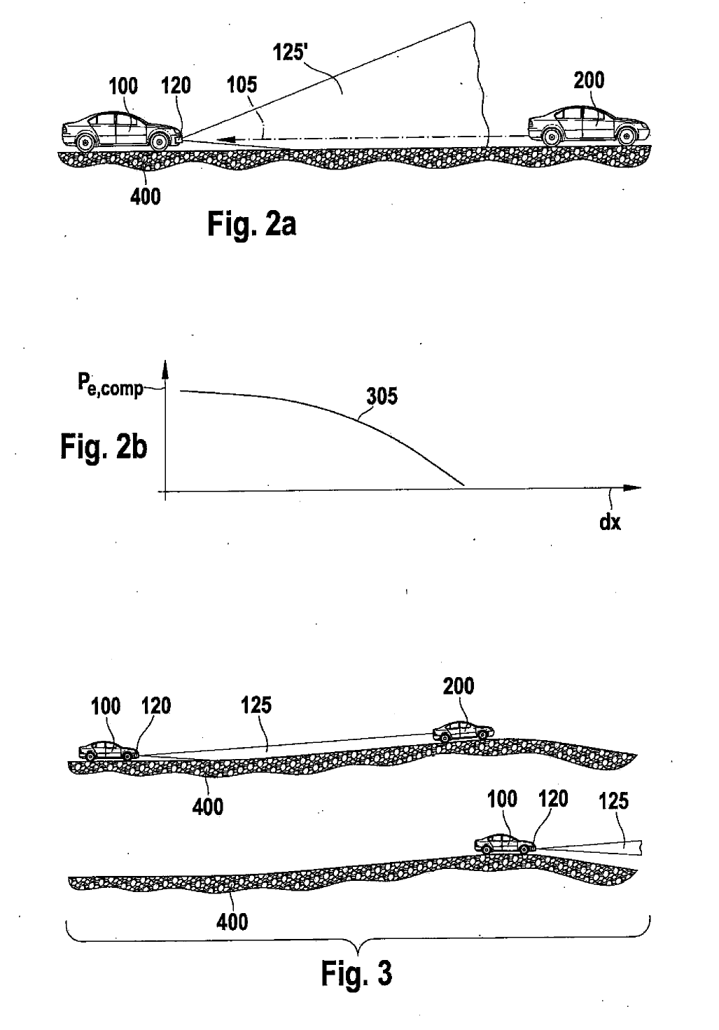

P_{e, comp}=Pₑ−20 log (G(α))+40 log(dx)+C

where C is a constant that is a function of the backscatter cross-section of object 200 and of various antenna constants or natural constants. These constants can remain unspecified, because only the shape of the curve of the compensated receive power need be evaluated. This is shown schematically in FIG. 1 by line 300. As can be seen in FIG. 1b, the compensated receive power does not change over the distance given a properly adjusted sensor. This is not true in the case of a misaligned radar sensor 120, where the sensor is inclined upward from vehicle longitudinal axis 105, for example due to a high trailer weight or due to misalignment caused by damage to the sensor mount or the like. The sensor field of view is schematically designated 125′ in FIG. 2a. In this case, the compensated receive power P_{e, comp} has a curve 305 that falls off as distance dx increases. From this gradient, the vertical misalignment can be inferred, and the angle of the misalignment can be determined from the magnitude of the gradient.

FIG. 3 schematically shows the situation in which both vehicles 100, 200 are traveling over a crest, because roadway 400 has an incline. In order to compensate the height problem, it is necessary to store the data until vehicle 100 has passed this point and the incline is known. Only then can the data be evaluated.

The incline can also be determined on the basis of the inherent acceleration and longitudinal acceleration of vehicle 100. The inherent acceleration and the longitudinal acceleration are already determined during operation of vehicle 100 by sensors that are required for example for vehicle dynamics controlling, such as stability programs and the like. As is schematically shown in FIG. 3, the situation in which vehicle 200 traveling in front passes over a crest does not permit determination of the vertical misalignment of sensor 120, because the vertical misadjustment in the case of a vehicle 200 traveling in front of the home vehicle at a different height position due to an incline cannot be distinguished from the vertical misalignment of sensor 120. False results can be reliably avoided by measuring the longitudinal acceleration and the inherent acceleration.

In order to minimize the statistical influence, data are advantageously acquired and averaged from many vehicles during the trip, and reports about the vertical misalignment of sensor 120 are made only on the basis of these averaged received and compensated receive powers over distance.

The example method described above can for example be implemented as a computer program on a computing device, in particular a control device of an internal combustion engine, and can be executed there. The program code can be stored on a machine-readable medium that the control device can read.

1-8. (canceled)

9. A method for recognizing a vertical misalignment of the radiation characteristic of a radar sensor of a control system for a motor vehicle, comprising:
determining a receive power of radar radiation reflected from an object at a distance;
compensating the receive power according to a distance dependency and a horizontal angular dependency in accordance with a radar equation to determine a functional dependence of the receive power;
comparing the compensated receive power with an expected and stored curve of receive power over the distance; and
inferring a vertical misalignment of a radiation characteristic of the radar sensor based on the comparison.

10. The method as recited in claim 9, wherein the object is another vehicle traveling in front of the vehicle, and the comparison is carried out only if both the vehicle and the vehicle traveling in front of the vehicle are not moving on an incline.

11. The method as recited in claim 10, wherein a presence of an incline is determined based on an inherent acceleration and longitudinal acceleration of the motor vehicle.

12. The method as recited in claim 9, wherein given a deviation of the compensated receive power from the expected receive power, a gradient of the compensated receive power is calculated, and an amount of the vertical misalignment of the radar sensor is determined based on the calculation.

13. The method as recited in claim 9, wherein the object is a vehicle that is approaching or moving away.

14. The method as recited in claim 9, wherein the stored receive power over the distance is an average value of a multiplicity of measured receive powers of radar scatter reflected by an object, with distance dependency and horizontal angular dependency compensated according to the radar equation.

15. A memory device storing a computer program, the computer program, when executed by a control device of a motor vehicle, causing the control device to perform:
determining a receive power of radar radiation reflected from an object at a distance;
compensating the receive power according to a distance dependency and a horizontal angular dependency in accordance with a radar equation to determine a functional dependence of the receive power;
comparing the compensated receive power with an expected and stored curve of receive power over the distance; and
inferring a vertical misalignment of a radiation characteristic of the radar sensor based on the comparison.

16. A machine readable medium storing a computer program, the computer program, when executed by a control device, causing the control device to perform:
determining a receive power of radar radiation reflected from an object at a distance;
compensating the receive power according to a distance dependency and a horizontal angular dependency in accordance with a radar equation to determine a functional dependence of the receive power;
comparing the compensated receive power with an expected and stored curve of receive power over the distance; and
inferring a vertical misalignment of a radiation characteristic of the radar sensor based on the comparison.
